(19) United States
(12) Patent Application Publication
(10) Pub. No.: US 2020/0181927 A1
(43) Pub. Date: Jun. 11, 2020

(54) IMPROVEMENTS RELATING TO SCAFFOLDING TIES

(71) Applicant: AVESTIN LIMITED, Sidmouth, Devon (GB)

(72) Inventor: Gavin BALUE, Sidmouth, Devon (GB)

(73) Assignee: AVESTIN LIMITED, Sidmouth, Devon (GB)

(21) Appl. No.: 16/316,436

(22) PCT Filed: Jul. 12, 2017
(86) PCT No.: PCT/GB2017/052047

§ 371 Date: Jan. 9, 2019

(30) Foreign Application Priority Data
Jul. 15, 2016 (GB) 1612352.3

(51) Int. Cl. E04G 7/04; E04G 21/28; F16B 2/08; F16B 5/06

(52) U.S. Cl. CPC E04G 7/04; E04G 21/28; E04G 5/12; F16B 5/0692; F16B 2/08

(57) ABSTRACT

An improved scaffolding tie 1 for connecting a scaffolding tarpaulin 8 to a scaffolding pole 9 is disclosed. The tie 1 comprises an anchor 4 for anchoring the tie 1 to the scaffolding tarpaulin 8, an attachment portion 6 for attaching the tie 1 to a scaffolding pole 9 and a ligament 5. The ligament 5 is connected between the anchor 4 and the attachment portion 6. The ligament 5 is arranged, in use, to bias the anchor 4 and attachment portion 6 towards one another. The attachment portion 6 comprises a fastening means 2 arranged, in use, to form a loop around a scaffolding pole 9 to attach the attachment portion 6 thereto. The fastening means 2 comprises a ratchet mechanism 26 arranged to restrain against expansion of the loop but permit ratcheted contraction of the loop.

### FIELD OF THE INVENTION

The present invention relates to a scaffolding tie. In particular, the present invention relates to a scaffolding tie for connecting a scaffolding tarpaulin to part of a scaffolding structure such as a scaffolding pole.

### BACKGROUND TO THE INVENTION

During external repair or other such construction work on buildings, a scaffolding structure is typically constructed in the region of the building requiring work. Scaffolding tarpaulins are then connected to scaffolding poles of the structure so as to protect the building and workers on the scaffolding structure from adverse environmental conditions, and also protecting against the danger of falling debris.

Scaffolding tarpaulins are connected to scaffolding poles by way of scaffolding ties. Prior-known scaffolding ties generally comprise an anchor, a hook and an elasticated cord between the anchor and hook. An example of such a prior-known tie is disclosed in European publication number 0310850 the content of which is hereby incorporated by reference to the extent permissible by applicable law.

Such prior-known ties suffer from a number of drawbacks.

The cord between the anchor and the hook generally needs to be long enough to enable it to extend from the tarpaulin to the scaffolding pole, and then looped around that scaffolding pole so that the hook can hook over the cord. The cord is a relatively expensive component of a tie, and so the need for such length increases the overall cost of a tie.

Furthermore, a long length combined with the elasticity of the cord means that the cord often has to be wound several times around the scaffolding pole to establish sufficient tautness to securely retain the scaffolding tarpaulin to the scaffolding pole. This is inconvenient and time-consuming for a scaffolder. Moreover, this can also compromise safety, especially if the scaffolder is having to maintain a constant force on the cord whilst winding the cord; doing so can unbalance the scaffolder.

Additionally, each time the cord is wound around a scaffolding pole represents a step-change in the tension in the cord. Accordingly, this can make it difficult to achieve the best level of tension in the cord. The correct level of tension may be achievable only via a half-turn of the cord around the pole, but this is not practical as a full turn is necessary to loop the hook around to meet with the unwound portion of the cord that extends between the pole and the anchor.

Another associated issue is that the hook is able to slip along the length of the cord. This causes the tie to loosen after hooking, potentially causing disengagement.

Prior to deconstruction of a scaffolding structure, a scaffolding tarpaulin needs to be decoupled from scaffolding poles. If prior-known scaffolding ties are to be reused, then a reverse operation of disengaging the hook and unwinding the cord is necessary to achieve the decoupling. This is also time-consuming and inconvenient. In practice, to save time, the cord of prior-known scaffolding ties are simply cut to achieve the quick release of the tarpaulin. This is wasteful.

It is against this background that the present invention has been devised.

### SUMMARY OF THE INVENTION

According to a first aspect of the present invention there is provided a scaffolding tie for connecting a scaffolding tarpaulin to a scaffolding pole. Preferably, the tie comprises at least one of an anchor for anchoring the tie to the scaffolding tarpaulin, an attachment portion for attaching the tie to a scaffolding pole, and a ligament connected between the anchor and the attachment portion. Preferably, the ligament is arranged to bias the anchor and attachment portion towards one another. Moreover, the ligament is preferably arranged to bias the anchor and attachment portion towards one another when the tie is in use, and the ligament is under tension. Preferably, the attachment portion comprises a fastening means arranged, in use, to form a loop around a scaffolding pole to attach the attachment portion thereto. Preferably, the tie comprises an adjustment means for adjusting the effective length of the tie. The adjustment means may comprise a ratchet mechanism arranged to permit ratcheted shortening of the effective length of the tie, the ratchet mechanism further arranged to restrain against the lengthening of the effective length of the tie. Preferably, the fastening means comprises a or the ratchet mechanism. Accordingly, the ratchet mechanism may be arranged to restrain against expansion of the loop but permit ratcheted contraction of the loop formed by the fastening means.

Advantageously, the adjustment means, and in particular, the ratchet mechanism allows quick and adjustable connection between the scaffolding tarpaulin and pole. This avoids one of the shortcomings of prior known scaffolding ties associated with the need to wind an elasticated portion multiple times around the scaffolding pole to obtain the correct effective length between the scaffolding pole and the scaffolding tarpaulin. This also saves material costs: the scaffolding tie need not be as long as prior known scaffolding ties. It will also be noted that a substantial length of prior known scaffolding ties is made up of a relatively costly elasticated portion, which is generally in the form of a bungee shock cord, or the like. Whilst the ligament of the present invention may comprise such a shock cord, the length of it can be significantly shorter, and so the cost of the scaffolding tie can be significantly reduced.

Another advantage is that the biasing action of the ligament, in combination with the attachment portion is useful in allowing a safer connection between the scaffolding pole and the scaffolding tarpaulin. Moreover, the ability provided by the attachment portion to change the effective length of the scaffolding tie does not necessarily influence the biasing action provided by the ligament. This means that the biasing force provided by the ligament is likely to lie within a predetermined range that is neither too small to prevent disengagement of the anchor from the scaffolding tarpaulin, nor too large to prevent a degree of slack between the scaffolding pole and the scaffolding tarpaulin. Such a degree of slack is useful to reduce the chance of damage to a scaffolding structure to which many scaffolding ties according to the first aspect are connected. Specifically, during high winds, the forces applied to a scaffolding structure by a distribution of such ties are not concentrated to a single connection point or region. Rather the biasing action of each of the bodies of the ties enables such wind forces to be spread out across the entire scaffolding structure. Shock forces are minimised, and so this can also prevent damage to the scaffolding tarpaulin.

Preferably, the scaffolding tie comprises a threading configuration in which the ligament extends in alignment with the anchor so as to facilitate threading of the anchor through a scaffolding tarpaulin. Preferably, the scaffolding tie comprises an anchoring configuration in which the ligament extends transverse to the anchor. This can impede disengagement of the anchor from the scaffolding tarpaulin through which the anchor is threaded, especially when the tie is in tensioned use.

Preferably, when the tie is in the threading configuration, the anchor, the attachment portion and the ligament are axially aligned with one another and arranged so that an axial force applied to the attachment portion in the direction of the anchor causes engagement of the attachment portion with the anchor. Advantageously, this can transmit the axial force from the attachment portion to the anchor, and so the transmitted axial force can facilitate threading of the anchor through a scaffolding tarpaulin. Furthermore, when the anchor and attachment portion are so aligned and engaged with one another, they together form a larger unit. This makes it easier for a user to grip the scaffolding tie to urge it to thread through a scaffolding tarpaulin. This is particularly useful if the scaffolding tarpaulin requires piercing.

Preferably, the anchor comprises a channel extending in alignment with the anchor. Preferably, the channel is arranged to accommodate within the anchor a stowable portion of the ligament when the tie is in the threading configuration. Preferably, the ligament is deflectable transverse to the anchor to remove the stowable portion of the ligament from the channel so as to switch the scaffolding tie to the anchoring configuration. Preferably, the stowable portion of the ligament extends transversely to the anchor from a central region of the anchor when the tie is in the anchoring configuration. Advantageously, this reduces anchor slippage and so increase the reliability with which the anchor operates when the ligament is subject to tension in use.

Preferably, the anchor defines a bore within which a first end portion of the ligament is retained. Ideally, the bore communicates with the channel so that the stowable portion of the ligament and the first end portion of the ligament are substantially contiguous.

Preferably, the tie further comprises at least one pin extending through the anchor and ligament to retain the anchor and ligament to one another. Preferably, the pin spans transversely across the bore. Preferably, the bore is a blind bore. Advantageously this limits insertion of the ligament into the anchor during manufacturing, increasing the reliability of the manufacturing process.

As mentioned, the ligament may comprises an elastic elongate member, such as a bungee shock cord. Moreover, the ligament may be the elastic elongate member.

Preferably, the anchor is constructed from an integral piece of material. Preferably, the anchor is moulded from an integral piece of material. The material may be a relatively inelastic plastics material.

Preferably, the anchor is elongate between a base at one end of the anchor, to an apex at the other end of the anchor. Ideally, the apex is suitable for puncturing an opening in a scaffolding tarpaulin through which the anchor is to be threaded. The apex may taper to a point or an edge. In alternatives, the apex may have other piercing constructions. For example, the apex may be shaped in the form of a drill bit. Preferably, the base provides a broad contact surface to facilitate the comfortable manual application of pressure to enable the apex to puncture an opening in the scaffolding tarpaulin.

Preferably, the attachment portion comprises a connector piece for connecting between the fastening means and the ligament.

Preferably, the length of the ligament is shorter than the combined axial length of the anchor and the attachment portion. Moreover, the length of the ligament may be shorter than the combined axial length of the anchor and connector piece. Advantageously, this facilitates the aforementioned ability for the anchor and the connector piece to engage with one another when the tie is in the threading configuration so that an axial force can be transmitted from the connector piece to the anchor. Specifically, when the tie is in the threading configuration, the anchor, the connector piece and the ligament are axially aligned with one another and arranged so that an axial force applied to the connector piece in the direction of the anchor causes engagement of the connector piece with the anchor. Advantageously, this can transmit the axial force from the connector piece to the anchor, and so the transmitted axial force can facilitate threading of the anchor through a scaffolding tarpaulin. Furthermore, when the anchor and connector piece are so aligned and engaged with one another, they together form a larger unit. This makes it easier for a user to grip the scaffolding tie to urge it to thread through a scaffolding tarpaulin. This is particularly useful if the scaffolding tarpaulin requires piercing.

It will also be noted that such axial engagement and transmission of force between the anchor and the attachment portion/connector piece is particularly advantageous over merely applying force to the anchor alone. Whilst the base of the anchor may have a broad contact surface to facilitate the comfortable manual application of pressure to enable the apex of the anchor to puncture an opening in the scaffolding tarpaulin, the engagement between the anchor and the attachment portion/connector piece provides a better structure for a user to manually grip and urge the anchor through a scaffolding tarpaulin.

Preferably, the connector piece defines a chamber through which the fastening means extends. Preferably, the chamber comprises a first slot and a second slot. Preferably, the first slot extends along a first path through the connector piece, and the second slot extending along a second path through the connector piece. The paths may meet at an intersection. Preferably, at least one of the first and second paths are linear paths.

The fastening means may comprises a head and a tail, the head defining a mouth through which the tail of the fastening means can be threaded to form the loop.

Preferably, the connector piece comprises a seat into which the head of the fastening means locates when the tail of the fastening means is threaded through one of the first and second slots. This can position the head at the path intersection. Moreover, this may position the head at the path intersection in an orientation that aligns the mouth of the head with the other of the first and second slots so that the mouth is in a position to receive the tail when it is threaded back through the other of the first and second slots.

Advantageously, this can increase the convenience and speed with which the fastening means can be manipulated manually by a user to form a loop. Certain fastening means such as cable ties are relatively fiddly to manipulate; the relatively small size of the tail and head make threading of the tail through the head difficult. Seating the head of the fastening means within the connector piece means that the tail can be more easily guided into the mouth of the head to form the loop; the seat and the slots guide the correct structures of the fastening means towards one another in a way reducing the effect of slight misalignments between such structures.

Preferably, at least one of the first and second slots are sized and arranged to permit threading through of the tail of the fastening means whilst also blocking passage of the head of the fastening means. Preferably, the tail of the fastening means and at least one of the first and second slots are sized and arranged relative to one another to restrain against relative rotation between the tail and at least one of the first and second slots. For example, the cross-sectional profile of at least one of the first and second slots may be non-circular. Furthermore, the tail of the fastening means may have a cross-sectional shape conforming closely to the cross-sectional profile of at least one of the first and second slots. Advantageously, this maximises the reliability with which the head of the fastening means is held at the correct position and/or orientation.

Preferably, the connector piece defines a bore within which a second end portion of the ligament is retained. Preferably, the bore is a blind bore. Advantageously this limits insertion of the ligament into the connector piece during manufacturing, increasing the reliability of the manufacturing process.

Preferably, the scaffolding, tie further comprising at least one pin extending through the connector piece and ligament to retain the connector piece and ligament to one another, the pin spanning transversely across the bore defined by the connector piece. Preferably, the connector piece is constructed from an integral piece of material. Preferably, the connector piece is moulded from an integral piece of material. The material may be a relatively inelastic plastics material.

Preferably, a tail of the fastening means comprises a band-like portion. Preferably, the band-like portion has a cross-section substantially corresponding to the cross-sectional size of a mouth of a head of the fastening means. Preferably, the band-like portion has equidistantly arranged ribs that cooperate with the mouth of the head of the fastening means to define the ratchet mechanism. Advantageously, where the band-like portion of the fastening means is flat or band-like, and the first and/or second slots defined by the connector piece closely conform in cross-section to that of the band-like portion, this further improves the orientation of the seated head.

The fastening means may be constructed from an integral piece of material. The fastening means may be moulded from an integral piece of material. The material may be a relatively inelastic plastics material. The fastening means may be in the form of a cable tie. Preferably, the ligament is constructed from a material that is substantially more elastic than at least one of the anchor, the fastening means and the connector piece.

According to a second aspect of the present invention there is provided a scaffolding tie for connecting a scaffolding tarpaulin to a scaffolding pole, the tie comprising an anchor for anchoring the tie to the scaffolding tarpaulin, an attachment portion for attaching the tie to a scaffolding pole, and a ligament connected between the anchor and the attachment portion, and arranged, in use, to bias the anchor and attachment portion towards one another. Preferably, the attachment portion is arranged to receive a fastening means to form a loop around a scaffolding pole to attach the attachment portion thereto.

According to a third aspect of the present invention, there may be provided a method of using a scaffolding tie according to the first and/or second aspect of the present invention.

A fourth aspect of the present invention may reside in a method of manufacturing a scaffolding tie according to the first and/or second aspect of the present invention.

Naturally, aspects of the present invention may extend to a plurality of scaffolding ties according to the first and/or second aspect of the present invention. Moreover, aspects of the present invention may reside in a scaffolding kit comprising one or more scaffolding poles, one or more scaffolding tarpaulins and a plurality of scaffolding ties according to the first or second aspect of the present invention. In practice, the plurality of scaffolding ties may be arranged to connect the one or more scaffolding tarpaulins to the one or more scaffolding poles, so as to form a sheltered scaffolding structure.

It will be understood that features and advantages of different aspects of the present invention may be combined or substituted with one another where context allows. For example, the features of the fastening means described in relation to the first aspect of the present invention may be present on the fastening means described in relation to the second aspect of the present invention. Furthermore, such features may themselves constitute further aspects of the present invention. For example, the anchor, the ligament and/or the attachment portion may constitute further aspects of the present invention.

### BRIEF DESCRIPTION OF THE DRAWINGS

In order for the invention to be more readily understood, embodiments of the invention will now be described, by way of example only, with reference to the accompanying drawings in which:

FIG. 1 is a lateral schematic view of the scaffolding tie in accordance with a first embodiment of the present invention, the scaffolding tie being shown schematically together with a scaffolding pole and a scaffolding tarpaulin, and the scaffolding tie being in a threading configuration;

FIG. 2 shows a similar view to FIG. 1, but with the scaffolding tie being in an anchoring configuration;

FIG. 3 is a lateral schematic view of a connector piece of the scaffolding tie of FIG. 1;

FIG. 4 is a front schematic view of the connector piece of FIG. 3;

FIG. 5 is an end schematic view of the connector piece of FIG. 3;

FIG. 6 is a perspective schematic view of the connector piece of FIG. 3;

FIG. 7 is a lateral schematic view of an anchor of the scaffolding tie of FIG. 1;

FIG. 8 is a front schematic view of the anchor of FIG. 7; and

FIG. 9 is an end schematic view of the anchor of FIG. 7.

### SPECIFIC DESCRIPTION

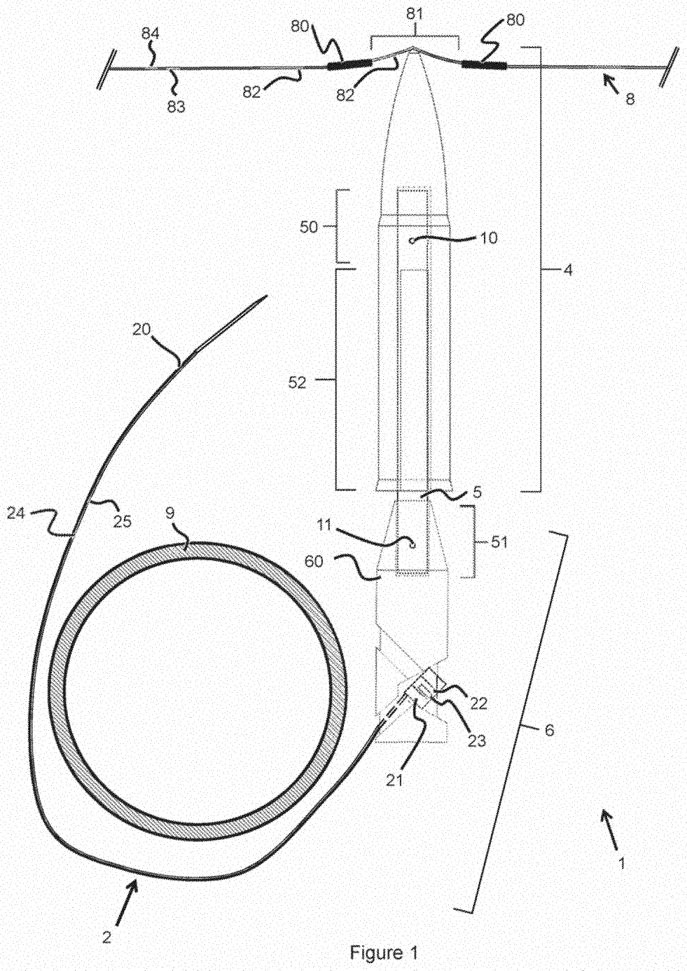

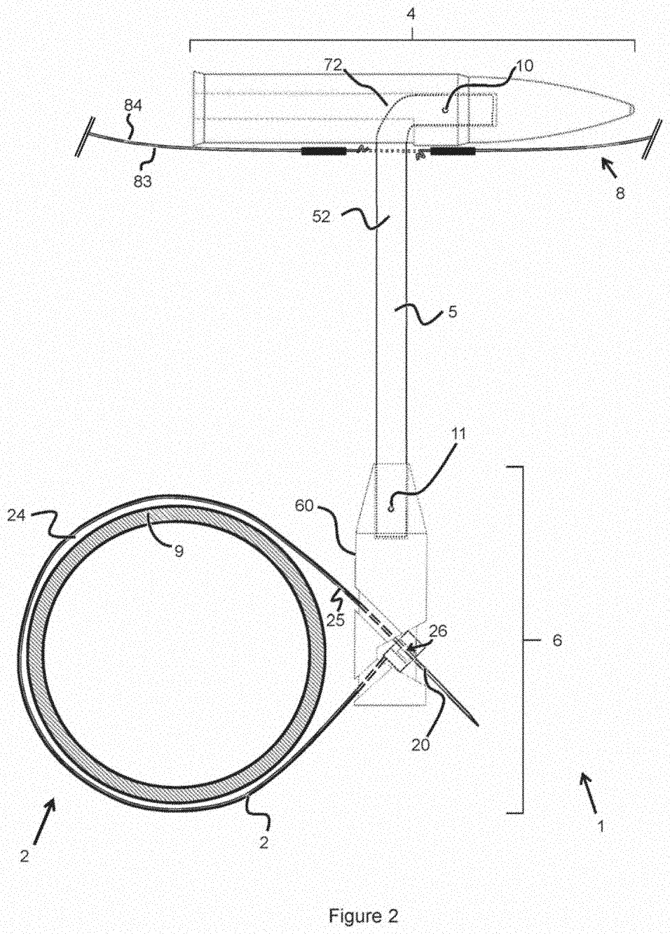

FIG. 1 is a schematic view of a scaffolding tie 1 according to a first embodiment of the present invention, the tie being shown prior to connection between a scaffolding tarpaulin 8 and a scaffolding pole 9. FIG. 2 show a similar schematic view to that of FIG. 1, but with the scaffolding tie 1 connected to the scaffolding tarpaulin 8 and the scaffolding pole 9, biasing them towards one another as will be described in greater detail below.

Referring to FIGS. 1 and 2, the tie 1 comprises an anchor 4, an attachment portion 6 and an elastic ligament 5 in the form of a bungee cord connected between the anchor 4 and the attachment portion 6. More specifically, the attachment portion 6 comprises a connector piece 60 and a fastening means 2, the ligament 5 being attached to the connector piece 60 so that the connector piece 60 connects between the ligament 5 and the fastening mean 2. The tie 1 also comprises a first pin 10 and a second pin 11 for connecting the ligament 5 to the anchor 4 and the connector piece 60 respectively.

The fastening means 2 follows the general form of a cable tie, and so comprises an enlarged head 21 that defines a mouth 22 through which a tail 20 of the fastening means 2 can be threaded. The head 21 comprises an integral locking member 23 disposed within the mouth 22. The tail 20 of the fastening means 2 comprises a band-like portion 24 that has a cross-section substantially corresponding to the cross-sectional size of the mouth 22 of the head 21 of the fastening means 2. Integrally-formed on an inside surface of the band-like portion 24 are equidistantly arranged ribs 25 that cooperate with the locking member 23 disposed within mouth 22 to define a ratchet mechanism 26 to allow the fastening means to form a constrictable loop.

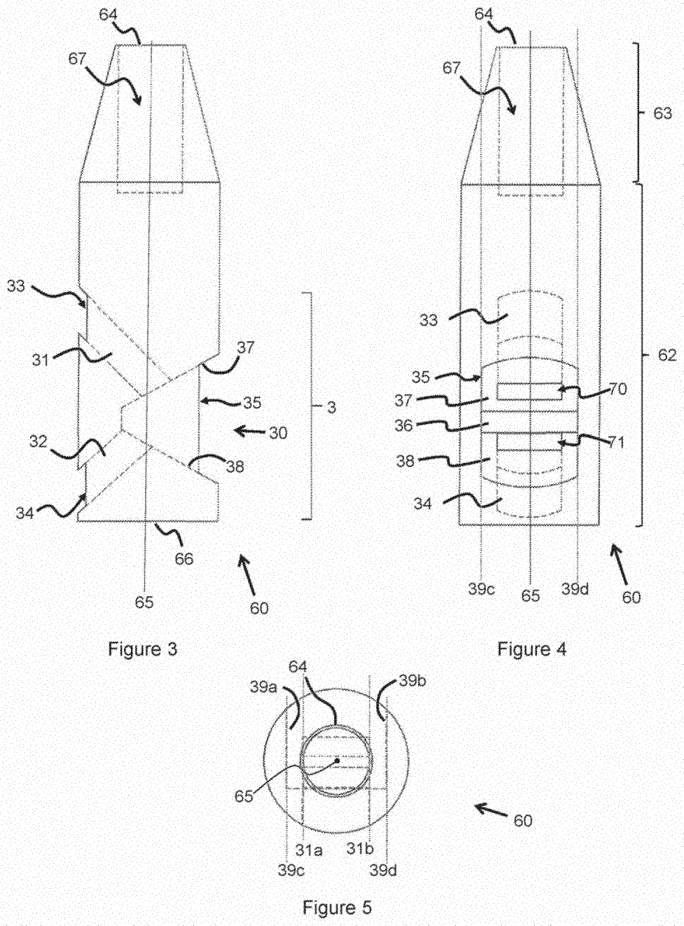

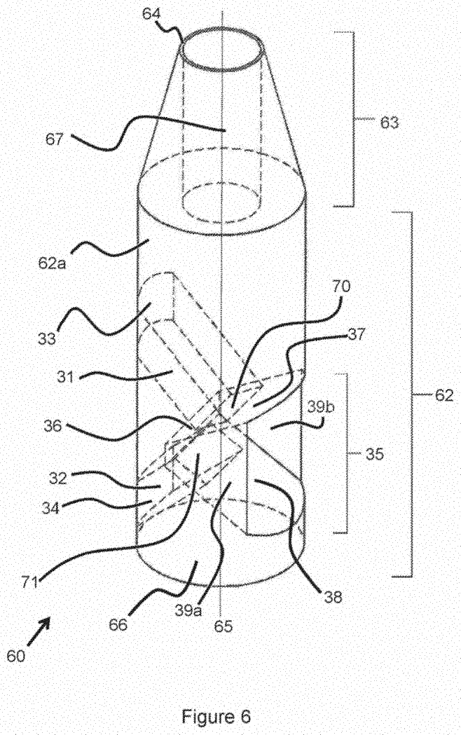

FIGS. 3 to 6 are various views of the connector piece 60 of the tie 1 of FIG. 1, the connector piece 60 being shown in isolation. The connector piece 60, which is formed from an inelastic integral piece of injection-moulded plastic, is elongated along a central axis 65 and has a broadly cylindrical body 62 that transitions into a frustoconical nose 63. The upper end of the nose 64 opens to define a cylindrical blind bore 67 which extends axially partway into the connector piece 60. The bore 67, the body 62 and the nose 63 of the connector piece 60 share the central axis 65 as a common axis. The body 62 of the connector piece 60 terminates at a flat circular end 66 at its lower end.

The body 62 of the connector piece 60 defines, between the circular end 66 and the nose 63, a chamber 3 which generally extends transverse to the central axis 65. Moreover, the chamber 3 comprise a trench 30, a first slot 31 and a second slot 32 which interrupt independent regions of the outer cylindrical surface of the body 62 of the connector piece 60, and so define three openings therein; a first opening 33 corresponding to the first slot 31, a second opening 34 corresponding to a second slot 32, and a third opening 35 corresponding to the trench 30. The trench 30, first slot 31, and second slot 32, extend inwardly from their respective openings towards one another and so communicate with one another within the body 62 of the connector piece 60. The first and second openings 33, 34 respectively associated with the first slot 31 and second slot 32 interrupt the outer cylindrical surface of the body 62 of the connector piece 60 at axially spaced, but circumferentially aligned positions to one another. The third opening 35 associated with the trench 30 is disposed at a circumferentially opposed position relative to the first and second openings 33, 34. Thus the chamber 3, generally extends transverse to the central axis 65, with one entrance defined by the third opening 35, and two exits defined by the first and second openings 33, 34. The third opening 35 is axially positioned between the first and second openings 33, 34, such that the second opening 34 is closest to the circular end 66 of the body 62, and the first opening 33 is the most distal from the circular end 66 of the body 62.

The trench 30 is broadly in the shape of a trapezoidal prism, and tapers in towards the interior of the body 62 of the connector piece 60. At its narrowest, the trench 30 forms a flat rectangular gully 36 which is surrounded by trench walls that extend between edges of the gully 36, and edges of the third opening 35. Specifically, a first trench wall 37 and a second trench wall 38 together define a pair that are inclined relative to one another, sloping inwardly from respective curved edges of the third opening 35 to respective edges of the gully 36, thereby defining the inward taper of the trench 30. A third trench wall 39, and a fourth trench wall 7 are each in the shape of an isosceles trapezium, and are congruent and parallel to one another, and extend along parallel trench planes xx that are aligned with and equispaced from the central axis 65.

The first slot 31 and the second slot 32 each define linear paths of rectangular cross-section, the cross-section of each path being broadly the same as one another. The first and second slots 31, 32 are commonly bounded by a pair of parallel slot planes xx, xx, that are aligned with and equispaced from the central axis 61. The slot planes xx, xx are also parallel to, and disposed between the trench planes xx, xx, and so the slot openings 33, 34 are narrower than the trench opening.

The first and second slots 31, 32 extend transverse to the central axis 61, along paths that meet at an intersection within the internal volume defined by the trench 30. Moreover, the first slot 31 extends from the first opening 33 to the first trench wall 37 such that a first rectangular aperture 70 interrupts the first trench wall 37 at a central region of the first trench wall 37. The second slot 32 extends from the second opening 34 to the second trench wall 38 such that a second rectangular aperture 71 interrupts the second trench wall 38 at a lower region of the first trench wall 37, with the second rectangular aperture 71 sharing an edge with the gully 36 of the trench 30. Thus, the first and second slots 31, 32 lead into the trench 30 at offset positions.

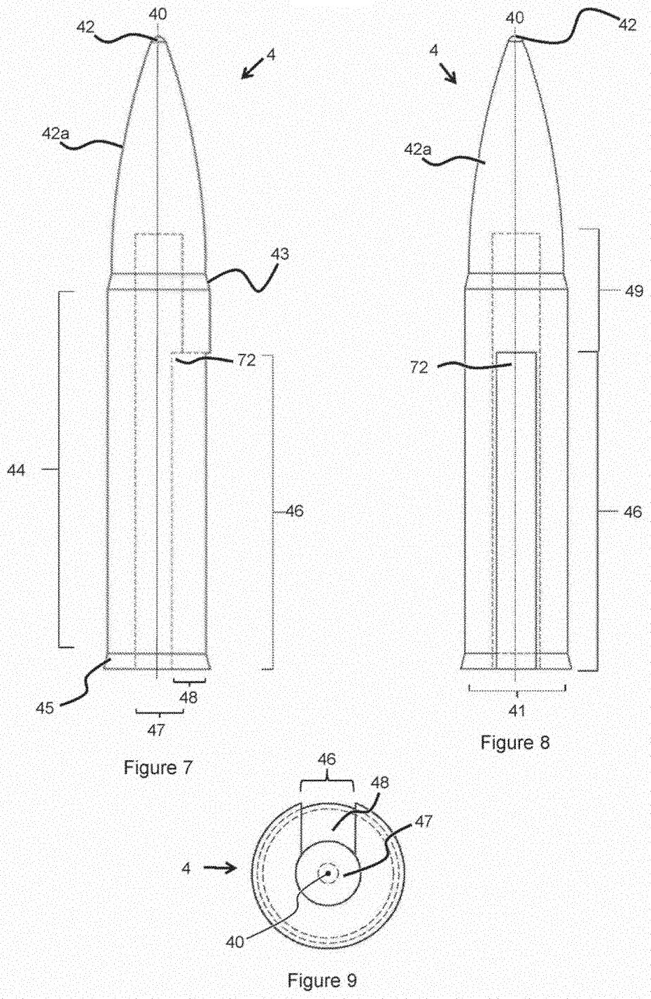

FIGS. 7 to 9 are various views of the anchor 4 of the tie 1 of FIG. 1, the anchor 4 being shown in isolation.

The anchor 4, which is formed from an inelastic integral piece of injection-moulded plastic, is elongate along a longitudinal axis 40 between a base 41 at one end of the anchor 4, to an apex 42 at the other end of the anchor 4. In the axial direction from the apex 42 to the base 41, the anchor 4 follows the general contour of a prolate spheroid, tapering outward sharply at its axially-upper end, and tapering outward more gently at its axially-lower end at which the anchor defines a frustoconical collar 43. The frustoconical collar 43 tapers constantly outward to meet a cylindrical shank 44 of the anchor 4. The shank 44 then extends with a regular outer circumference between the collar 43 and a frustoconical rim portion 45 of the anchor 4. The frustoconical rim portion 45 then tapers constantly outward before terminating at the base 41. Thus, the anchor 4 is broadly bullet-shaped in its overall shape.

The anchor 4 defines a channel 46 that extends partway along the longitudinal length of the anchor 4 in alignment with the longitudinal axis 40 of the anchor 4, the channel 46 extending between the base 41 and a central region 72 of the anchor 4. The channel 46 comprises a radially-inner cylindrical core 47, which is centred on the longitudinal axis 41, and a radially-outer rectangular groove 48, the groove 48 interrupting the outer surface of the shank 44 and the rim 45.

The anchor 4 also defines internal cylindrical blind bore 49 which is effectively an extension of the cylindrical core 47 of the channel 46, the bore extending axially partway along the longitudinal length of the anchor 4 between the central region 72 of the anchor 4 and the apex 42. Thus the bore 49 and the channel 46 communicate with one another.

Referring back to FIGS. 1 and 2, a first end portion 50 of the ligament 5 is attached to the anchor 4 by way of the first pin 10 extending through the anchor 4 and the first end portion 50 of the ligament 5, pinning them to one another. Specifically, the first pin 10 extends through the shank 44 of the anchor 4, bisecting the longitudinal axis 40 and so centrally through the first end portion 50 of the ligament 5, the first pin 10 spanning transversely across the blind bore 49 of the anchor. Similarly, a second end portion 51 of the ligament 5 is attached to the connector piece 60 via the second pin 11 which extends transversely through the nose 63 of the connector piece 60 and the ligament 5.

Use of the scaffolding tie will now be described.

FIG. 1 shows the scaffolding tie 1 in a threading configuration in which the ligament 5 extends in alignment with the anchor 4 so as to facilitate threading of the anchor 4 through a scaffolding tarpaulin 8. Moreover, the channel 46 is arranged to accommodate within the anchor 4 a stowable portion of the ligament 5 so that the ligament 5 does not extend circumferentially beyond any radially-outwardly facing surface of the anchor 4, but rather extends axially from the base 41 of the anchor.

As is well-known in the art, the scaffolding tarpaulin 8 comprises an eyelet 80 which forms a reinforced region of the scaffolding tarpaulin 8 to which the scaffolding tie can reliably attach. Initially, an eye 81 of the eyelet 80 is occluded by webbing 82 from which the tarpaulin 8 is predominantly constructed, and so the eye 81 does not form an opening that passes all the way through, from one side of the tarpaulin 8 to the other, but rather first requires puncturing.

Naturally, the tapered apex 42 of the anchor 4 is suitable for puncturing such an opening in the scaffolding tarpaulin 8. This is facilitated by the structure of the anchor 4 in that the apex 42 tapers to a point and the base 41 provides a broad contact surface to enable a user to comfortably transmit the force required to the apex 42 to puncture the opening in the scaffolding tarpaulin 8.

However, puncturing of the scaffolding tarpaulin 8 is even further facilitated by the interaction between the anchor 4 and the connector piece 60. As can be seen in FIG. 1, when the tie is in the threading configuration, the anchor 4, the connector piece 60 and the ligament 5 are axially aligned with one another. This aligned arrangement forms an elongate unit that is substantially as long as the combined axial length of the anchor 4 and the connector piece 60. This makes the unit easier for a user to grip the scaffolding tie 1 to urge it to thread through a scaffolding tarpaulin 8 to pierce it. Moreover, the anchor 4 and the connector piece 60 are arranged so that an axial force applied to the connector piece 60 in the direction of the anchor 4 causes engagement of the connector piece 60 with the anchor 4. Whilst the schematic view of FIG. 1 shows a slight separation between the anchor 4 and the connector piece 60 that is bridged by the ligament 5, in practice, urging the connector piece 60 towards the anchor 4 causes engagement between the upper end of the nose 64 of the connector piece 60 and the base 41 of the anchor 4. The general compliance of the ligament 5 allows it to be axially compressed so that the separation between the anchor 4 and the connector piece 60 is closed under the application of force by a user to drive the anchor 4 and connector piece 60 together. At the same time, the compressed ligament 5 does not extend circumferentially beyond any radially-outwardly facing surface of the anchor 4, and so does not interfere with threading of the anchor 4 through the scaffolding tarpaulin 8. Thus an axial force can be transmitted from the connector piece 60 to the anchor 4, and this can be used to drive the anchor 4 through a scaffolding tarpaulin 8.

Specifically, the anchor 4 is driven from an internally-facing surface 83 of the tarpaulin 8, which faces the scaffolding pole, through to an externally-facing surface 84 of the tarpaulin 8 which faces externally relative to the scaffolding structure. When the anchor 4 has passed completely through the tarpaulin 8, the scaffolding tie 1 can be switched from the threading configuration, as shown in FIG. 1, to the anchoring configuration, and shown in FIG. 2. In part, this is achieved by manually deflecting the ligament 5 and the anchor 4 out of axial alignment with one another so that the stowable portion 52 of the ligament 5 extends from the central region 72 of the anchor in an orientation that is transverse to the longitudinal orientation of the anchor 4. Moreover, the anchor 4 lies flat along the externally-facing surface 84 of the tarpaulin 8 around the eyelet 80, and is able to draw the tarpaulin 8 towards the scaffolding structure located on the side of the reverse internally-facing surface 83 of the tarpaulin 8. This is achieved via the biasing action of the ligament 5 in combination with the constrictable loop defined by the fastening means 2.

As mentioned, the fastening means 2 is in the general form of a cable tie, and so is a separate component to the connector piece 60, and so is completely unconnected initially to the other components of the scaffolding tie 1 such as the ligament 5 and the anchor 4.

Connection of the fastening means 2 to the connector piece 60 is carried out in two stages. In a first stage, the tail 20 is threaded through the chamber 3 of the connector piece 60 by passing it into the third opening 35, through the second slot 32 and out of the second opening xx. Drawing the tail 20 of the fastening means 2 completely through the second slot 32 pulls the head 21 of the fastening means into the trench 30. The head 21 is small enough to fit into the trench 30 but too large to pass through the second slot 32 and so is caught within the trench 30. Moreover, the trench walls 37, 38, 39, 7 and gully 36 define a seat into which the head 21 of the fastening means 2 locates when the tail 20 of the fastening means 2 is fully threaded through the second slot 32. The seat positions the head 21 so that the head 21 is located at the intersection of the paths along which the first and second slots 31, 32 extend, and moreover, the mouth 22 of the head 21 is aligned with the path along which the first slot 31 extends. This position is that shown in FIG. 1.

In a second stage of connecting the fastening means 2 to the connector piece 60, the tail 20 of the fastening means 2 is looped back and urged into the first opening 33 of the connector piece 60. Thus, the tail 20 is guided by the first slot 31 towards and through the mouth 22 of the head 21 of the fastening means 2 to form a complete loop. The locking member 23 cooperates with the ribs 25 disposed on the band portion 24 of the tail 20 so that the further feeding of the tail 20 through the head 21 constricts the loop, but an attempt to withdraw the tail 20 in the reverse direction is restrained by the locking member 23. This position is that shown in FIG. 2.

As also shown in FIG. 2, in use, the fastening means 2 is looped around the scaffolding pole 9 and so serves to connect the connector piece 60 and the scaffolding pole 9 to one another. Moreover, the ratchet mechanism 26 allows the loop defined by the fastening means 2 to be irreversibly tightened drawing the connector piece 60 and the scaffolding pole 9 together. This can be achieved by a user by pulling on the part of the tail 20 that has already passed through the head 21 of the fastening means 2. As shown in FIG. 2, this part accessibly protrudes through the third opening 35 of the connector piece 60. Constricting the loop in this way shortens the effective length of the scaffolding tie 1 so that the anchored part of the scaffolding tarpaulin 8 is drawn towards the scaffolding pole 9. This also tensions the elastic ligament xx, thereby biasing the scaffolding pole xx and the scaffolding tarpaulin xx towards one another.

As mentioned, the first and second slots 31, 32 lead into the trench 30 at offset positions, and this is to compensate for the spacing on the head xx between the tail xx and the mouth xx of the fastening mean xx. Accordingly, it is preferred in use that the tail xx of the fastening means xx is first threaded through the second slot xx. However, in an alternative use, it is also possible for the tail xx of the fastening means xx to be first threaded through the first slot xx. Whilst this does not cause the most optimal alignment the mouth xx, the first and second slots 31, 32 both effectively guide the looped-back tail xx into the mouth xx of the fastening means.

Other alternatives to, and advantages of the above-described embodiments will be apparent to a person skilled in the art.

For example, in alternatives, the apex may have other piercing constructions. For example, the apex may be shaped in the form of a drill bit. Accordingly, the anchor and/or the connector piece may be provided with ridges to improve the manual grip with which a user leverages such an apex construction—namely via a twist-push action.

The use of retaining means such as pins in combination with a blind bore in the anchor and the connector piece is particularly useful during the manufacture of the scaffolding tie. The blind bore limits the depth of insertion of the ligament into the blind bore, thereby reliably ensuring a consistent length of ligament is retain within the bore, and also a consistent length can be provided outside the bore. A pin is then simply plunged into place. Nonetheless, in alternatives, other retaining means may be used to retain the ligament to the anchor and/or the connector piece. For example, staples may take the place of the pins described in relation to the first embodiment. Furthermore, adhesive may be applied within the blind bores of the anchor and/or connector piece either in addition to the pins or staples, or instead of them, to retain the ligament therein.

Notably, the retaining means should ideally be chosen to provide a predetermined binding force between the ligament and the anchor and/or connector piece. This is so that the scaffolding tie breaks at high wind speeds to enable scaffolding tarpaulin to come away from the underlying scaffolding structure. This is a safety feature that reduces the chance that the scaffold will be damaged or toppling due to the influence of excessive wind forces.

The fastening means represents a separate component that is to be connected in use to the already combined connector piece, ligament and anchor. In alternatives, the fastening means may be already combined with the connector piece, or integral with it. However, it is preferred for the fastening means to remain as a separate component. This is because it is a relatively inexpensive component that can be cheaply replaced, facilitating reuse of a relatively expensive connector piece, ligament and anchor of the scaffolding tie. Specifically, before a scaffolding structure is deconstructed, the scaffolding tarpaulin can be quickly decoupled from scaffolding poles by cutting through the fastening means to achieve quick release of the tarpaulin. The anchor, ligament and connector piece of the scaffolding tie can then be retrieved from the released tarpaulin, or simply left lying in position across the eyelet for subsequent use of the tarpaulin and tie.

Although the invention has been described in conjunction with specific embodiments thereof, it is evident that many alternatives, modifications and variations will be apparent to those skilled in the art. Accordingly, it is intended to embrace all such alternatives, modifications and variations that fall within the scope of the appended claims.

1. A scaffolding tie for connecting a scaffolding tarpaulin to a scaffolding pole, the tie comprising:
an anchor for anchoring the tie to the scaffolding tarpaulin;
an attachment portion for attaching the tie to a scaffolding pole; and
a ligament connected between the anchor and the attachment portion, and arranged, in use, to bias the anchor and attachment portion towards one another;
wherein, the attachment portion comprises a fastening means arranged, in use, to form a loop around a scaffolding pole to attach the attachment portion thereto, the fastening means comprising a ratchet mechanism arranged to restrain against expansion of the loop but permit ratcheted contraction of the loop.

2. A scaffolding tie according to claim 1, wherein the scaffolding tie comprises:
a threading configuration in which the ligament extends in alignment with the anchor so as to facilitate threading of the anchor through a scaffolding tarpaulin; and
an anchoring configuration in which the ligament extends transverse to the anchor so as to, in use of the tie, impede disengagement of the anchor from the scaffolding tarpaulin through which the anchor is threaded.

3. A scaffolding tie according to claim 2, wherein, when the tie is in the threading configuration, the anchor, the attachment portion and the ligament are axially aligned with one another and arranged so that an axial force applied to the attachment portion in the direction of the anchor causes engagement of the attachment portion with the anchor, thereby transmitting the axial force from the attachment portion to the anchor, the transmitted axial force being operative to thread the anchor through a scaffolding tarpaulin.

4. A scaffolding tie according to claim 2, wherein the anchor comprises a channel extending in alignment with the anchor, the channel being arranged to accommodate within the anchor a stowable portion of the ligament when the tie is in the threading configuration, the ligament being deflectable transverse to the anchor to remove the stowable portion of the ligament from the channel so as to switch the scaffolding tie to the anchoring configuration, the stowable portion of the ligament extending transversely to the anchor from a central region of the anchor when the tie is in the anchoring configuration.

5. A scaffolding tie according to claim 4, wherein the anchor defines a bore within which a first end portion of the ligament is retained, the bore communicating with the channel so that the stowable portion of the ligament and the first end portion of the ligament are substantially contiguous.

6. A scaffolding tie according to claim 5, wherein the tie further comprises at least one pin extending through the anchor and ligament to retain the anchor and ligament to one another, the pin spanning transversely across the bore.

7. A scaffolding tie according to claim 1, wherein the ligament comprises an elastic elongate member, such as a bungee shock cord.

8. A scaffolding tie according to claim 7, wherein the ligament is the elastic elongate member.

9. A scaffolding tie according to claim 1, wherein the anchor is constructed from an integral piece of material.

10. A scaffolding tie according to claim 1, wherein the anchor is elongate between a base at one end of the anchor, to an apex at the other end of the anchor, the apex being suitable for puncturing an opening in a scaffolding tarpaulin through which the anchor is to be threaded.

11. A scaffolding tie according to claim 10, wherein the apex tapers to a point or an edge.

12. A scaffolding tie according to claim 1, wherein the attachment portion comprises a connector piece for connecting between the fastening means and the ligament.

13. A scaffolding tie according to claim 12, wherein the length of the ligament is shorter than the combined axial length of the anchor and connector piece.

14. A scaffolding tie according to claim 12, wherein the connector piece defining a chamber through which the fastening means extends, the chamber comprising a first slot and a second slot, the first slot extending along a first path through the connector piece, and the second slot extending along a second path through the connector piece, the paths meeting at an intersection.

15. A scaffolding tie according to claim 14, wherein:
the fastening means comprises a head and a tail, the head defining a mouth through which the tail of the fastening means can be threaded to form the loop; and
the connector piece comprises a seat into which the head of the fastening means locates when the tail of the fastening means is threaded through one of the first and second slots such that the head is positioned at the path intersection in an orientation that aligns the mouth of the head with the other of the first and second slots so that the mouth is in a position to receive the tail when it is threaded back through the other of the first and second slots.

16. A scaffolding tie according to claim 14, wherein:
the fastening means comprises a head and a tail, the head defining a mouth through which the tail of the fastening means can be threaded to form the loop; and
at least one of the first and second slots are sized and arranged to permit threading through of the tail of the fastening means whilst also blocking passage of the head of the fastening means.

17. A scaffolding tie according to claim 14, wherein:
the fastening means comprises a head and a tail, the head defining a mouth through which the tail of the fastening means can be threaded to form the loop; and
the tail of the fastening means and at least one of the first and second slots are sized and arranged relative to one another to restrain against relative rotation between the tail and at least one of the first and second slots.

18. A scaffolding tie according to claim 17, wherein the cross-sectional profile of at least one of the first and second slots are non-circular, and the tail of the fastening means has a cross-sectional shape conforming closely to the cross-sectional profile of at least one of the first and second slots.

19. A scaffolding tie according to claim 12, wherein the connector piece defines a bore within which a second end portion of the ligament is retained, the tie further comprising at least one pin extending through the connector piece and ligament to retain the connector piece and ligament to one another, the pin spanning transversely across the bore defined by the connector piece.

20. A scaffolding tie according to claim 12, wherein the connector piece is constructed from an integral piece of material.

21. A scaffolding tie according to claim 1, wherein a tail of the fastening means comprises a band-like portion having a cross-section substantially corresponding to the cross-sectional size of a mouth of a head of the fastening means, the band-like portion having equidistantly arranged ribs that cooperate with the mouth of the head of the fastening means to define the ratchet mechanism.

22. A scaffolding tie according to claim 1, wherein the fastening means is constructed from an integral piece of material.

23. A scaffolding tie according to claim 1, wherein the fastening means is a cable tie.

24. A scaffolding tie for connecting a scaffolding tarpaulin to a scaffolding pole, the tie comprising:
an anchor for anchoring the tie to the scaffolding tarpaulin;
an attachment portion for attaching the tie to a scaffolding pole; and
a ligament connected between the anchor and the attachment portion, and arranged, in use, to bias the anchor and attachment portion towards one another, the attachment portion being arranged to receive a fastening means to form a loop around a scaffolding pole to attach the attachment portion thereto.

25-27. (canceled)
